(19) United States
(12) Patent Application Publication
(10) Pub. No.: US 2011/0246153 A1
(43) Pub. Date: Oct. 6, 2011

(54) METHOD FOR PELLET CLADDING INTERACTION (PCI) EVALUATION AND MITIGATION DURING BUNDLE AND CORE DESIGN PROCESS AND OPERATION

(76) Inventors: Benjamin James Schultz, Wilmington, NC (US); Michael William Thomas, Wilmington, NC (US); Shawn Marie Lamb, Wilmington, NC (US); Harold Hartney Yeager, Wilmington, NC (US); Robert J. Schneider, Wilmington, NC (US); Charles Carter McNeely, Wilmington, NC (US); Richard Augi, Wilmington, NC (US)

(21) Appl. No.: 12/753,968

(22) Filed: Apr. 5, 2010

(51) Int. Cl. G06G 7/54; G06G 7/48

(52) U.S. Cl. 703/6; 703/18

(57) ABSTRACT

Example embodiments are directed to a method of fuel bundle design, core design, or combined fuel and core design, to ensure Pellet Cladding Interaction (PCI) related fuel failures are mitigated. More specifically, example embodiments provide fuel and/or core designs that may be determined prior to operation of a nuclear power plant, or prior to production of fresh fuel bundles. The PCI optimized fuel/core designs may include some or all of seven PCI Evaluation Methods which may be incorporated into existing nuclear reactor simulation programs. PCI optimized fuel and/or core design enhances fuel reliability, allows faster beginning-of-cycle (BOC) startups and faster middle-of-cycle (MOC) sequence exchanges to maximize plant performance, and minimizes ramping restrictions, thereby maximizing nuclear power plant performance.

### BACKGROUND OF THE INVENTION

1. Field of the Invention

Example embodiments relate in general to a method of evaluating risk factors for, and mitigating the occurrence of, Pellet Cladding Interaction (PCI) type fuel failures.

2. Related Art

In a Boiling Water Nuclear Reactor (BWR), or in a Pressurized Water Reactor (PWR), nuclear fuel rods are present in the core and contain enriched nuclear fuel such as ceramic pellets of uranium dioxide enriched in a U-235 isotope. Such nuclear fuel rods, also called pins, are metallic tubular shells, or cladding which are hermetically sealed at their ends and contain fuel pellets. Fuel rods are grouped into fuel bundles also called assemblies.

A nuclear reactor generally operates from one to two years on a single core of nuclear fuel. Upon completion of this period, which is known as a “cycle,” approximately ¼ to ½ (or, on average ⅓) of the least reactive fuel (i.e., the oldest, or most burnt fuel) is discharged from the reactor. The number of fuel bundles that are discharged are replaced by an equal number of fresh fuel bundles. Operation of the cycle greatly depends on placement of the fuel bundles (fresh, once-burnt, twice-burnt, etc.). Due to the presence of burnable poisons, such as Gadolinium, the characteristics of fresh, once-burnt, and twice-burnt bundles are different.

A fresh fuel bundle is typically less reactive at the Beginning-of-Cycle (BOC), as opposed to once-burnt fuel, due to the presence of Gadolinium. However, at the End-of-Cycle (EOC) the poison has been burnt out, making fresh bundles more reactive than the once-burnt fuel. Although the shape of an exposure dependent reactivity curve of twice-burnt fuel is similar to that of the once-burnt fuel, the reactivity of the twice-burnt fuel is smaller in magnitude. By combining fresh, once-burnt, and twice-burnt bundles, a generally even reactivity can be achieved throughout the core, and throughout the cycle.

Fuel bundle design and the core design (including bundle loading and rod patterns) define some of the more important considerations for a nuclear fuel cycle. Overall placement of fuel bundles impacts core reactivity, thermal limits, power shaping, and fuel cycle economics. For example, cycle length can be increased by the placement of a greater number of reactive bundles toward the center of the core. However, if bundles that are too high in reactivity are located in positions that are adjacent to each other, inadequate margin in reactivity thresholds and thermal limits may result in damage to fuel rod cladding.

Fuel rod cladding maintains structural integrity, as the cladding is the first barrier to fission products being released into the environment. Nuclear fuel cladding is generally formed from zirconium or a zirconium alloy. During operation of a nuclear reactor, fission products are generated within the fuel pellets. When power is increased quickly, the fuel pellets can expand and exert stress on the cladding, and fission products may be released and may contribute to stress corrosion and in some cases failure of the metallic tubular cladding. This phenomenon is known as Pellet Cladding Interaction (PCI). It has been determined that PCI failures occur when Zircaloy cladding is simultaneously subjected to sufficient levels of (newly released) embrittling fission products and tensile hoop stress. Fission products such as iodine, cesium, cadmium or other elements increase the operating stresses on the cladding and may result in penetration and failure of the walls of the cladding. Failures of the cladding may include the development of one or more openings or cracks/holes which permit the escape of fission products from the fuel element into the surrounding coolant.

During a rapid power increase, particularly following a period of extended low power operation, both the inventory of newly released fission gases and the cladding hoop stress can be large. There are two fundamental mitigation methods to reduce this duty-related performance risk known as PCI: either (1) reduce the duration of the low power period between higher power operation, or (2) reduce the rate at which power is increased.

Conventionally, preconditioning power “envelopes,” thresholds, and ramp rates have been developed to limit power increases to minimize occurrences of these types of failures. Additionally, restrictions on controlled operations have been implemented to mitigate PCI.

### SUMMARY OF INVENTION

Example embodiments provide a comprehensive fuel and core designs to ensure that one or more performance metrics are achieved while mitigating PCI. More specifically, example embodiments provide fuel and core designs that may be determined prior to operation or even prior to the production of fuel bundles, thereby offering a core design providing enhanced one or more of fuel reliability, faster beginning-of-cycle (BOC) startups and faster middle-of-cycle (MOC) sequence exchanges to maximize plant performance, and minimized ramping restrictions.

Example embodiments are drawn to various combinations of seven evaluations that may be applied to the overall nuclear reactor core, to individual fuel bundles, or to individual lattices or nodes within a bundle or across a strata of the reactor core. The evaluations may include: 1) an evaluation of a lattice local peaking factor, 2) a focused axial evaluation and determination of axial limits, 3) an evaluation of controlled fuel at beginning-of-cycle (BOC) N (cycle N being a cycle following projected refueling) and end-of-cycle (EOC) N−1 (cycle N−1 being a cycle before projected refueling), 4) an evaluation of uncontrolled bundle exposure at BOC, 5) an evaluation of a final rod pattern before All-Rods-Out (ARO) in cycle N, 6) an evaluation of conditioning envelopes throughout cycle N, and 7) an evaluation of the power history of fuel bundles and nodes.

Example embodiments include a method of collusively including some or all of the seven evaluations to provide a comprehensive method of designing individual fuel bundles for later use during operation. The evaluations may also be used to provide an overall core design that may be determined prior to operation.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a perspective view of a conventional fuel bundle;

FIG. 2 is a cross-sectional view of four conventional fuel bundles;

FIG. 3 is an exemplary diagram of a Radial Power Distribution for a lattice of a fuel bundle, used in example embodiments;

FIG. 4 is an exemplary Axial Power Distribution for a fuel bundle, used in example embodiments;

FIG. 5 is an exemplary diagram of different Thermal Mechanical Limits for Gadolinia and UO₂ (Uranium Dioxide) rods, used in example embodiments;

FIG. 6 is an exemplary cross-sectional diagram of fuel bundles in a nuclear reactor core, used in example embodiments;

FIG. 7 is an exemplary power history diagram showing a preconditioning threshold and three optional Linear Heat Generation Rate (LHGR) thresholds (Option A or B) for a fuel bundle, used in example embodiments;

FIG. 8 is an exemplary power history graph for a fuel bundle, used in example embodiments;

FIG. 9 is a exemplary “waterfall” exposure graph, used in example embodiments;

FIG. 10 is an example embodiment of a methodology for fuel bundle design and core design including Pellet Cladding Interaction (PCI) mitigation;

FIG. 11 is an example embodiment of a methodology for fuel bundle design and core design including PCI mitigation; and

FIG. 12 is an arrangement for implementing the method in accordance with example embodiments.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

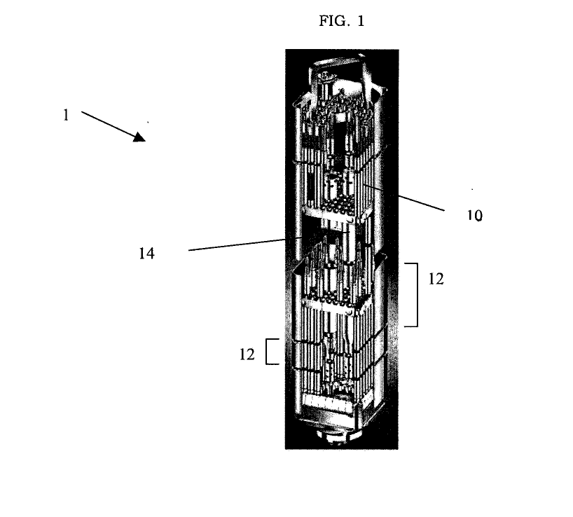

Referring to FIG. 1, a conventional fuel bundle 1 for a nuclear Boiling Water Reactor (BWR) with nuclear fuel rods 10 including enriched U-235 isotope is shown. The individual fuel rods 10 may be hermetically sealed metallic tubular shells made of zirconium, or zirconium alloy. Each fuel bundle 1 contains several different axially-varying lattices 12 that may have varying cross-sectional enrichments of uranium. Lattices 12 generally consist of a uniform N×N (e.g. 9×9, 10×10, etc.) array of fuel rods 10, with one or more water rods 14 that may run through the center of the bundle 1. Fuel rods 10 are designed to include varying concentrations and combinations of uranium, for fuel, and a moderator such as Gadolinia.

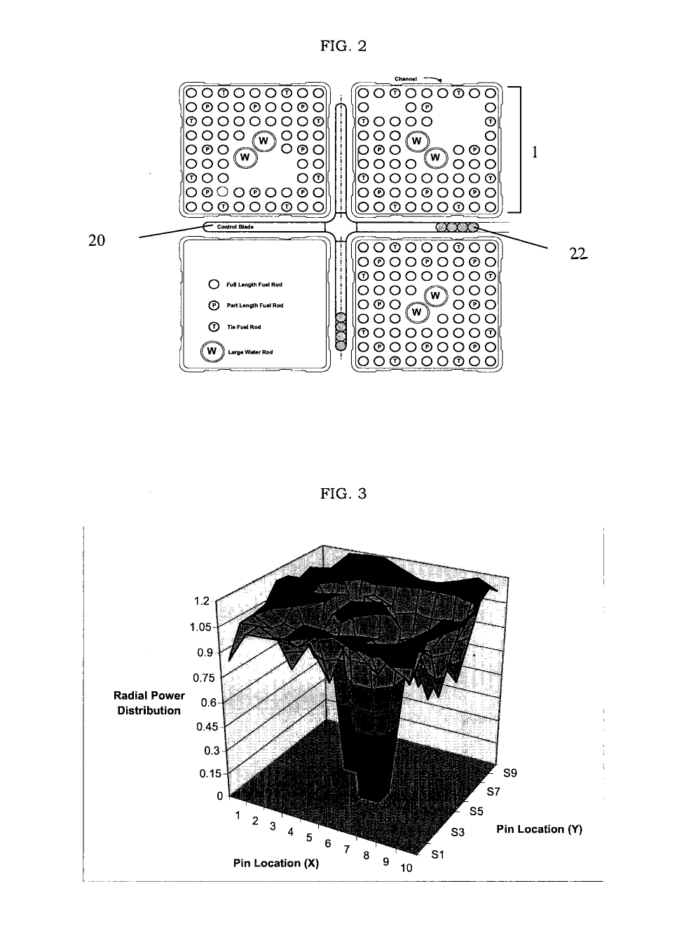

An example cross-section of four fuel bundles 1 is shown in FIG. 2. A control blade 20 is a cruciform-shaped device containing tubes 22 of burnable poison. These typically control reactivity for power maneuvering and are inserted in between a cell of the four individual fuel bundles 1. A bundle 1 whose associated control blade 20 is inserted is called “controlled.” A bundle 1 whose associated control blade 20 is not inserted is called “uncontrolled.” A node is a small axial segment, such as a 6-inch axial segment of a fuel bundle 1 and/or control blade 20. Lattices are generally larger axial cross-sections that contain at least one node.

Example embodiments are drawn to a method of evaluating an overall reactor core, individual bundles, lattices within a bundle, and individual nodes, to mitigate PCI. This analysis may be done before or during operation. Because the evaluations may be done prior to operation, data and results may be simulated on a computer, thereby allowing for fuel bundle and core design to be determined before plant operation and/or before fuel bundles are even designed or manufactured. Described below is an example embodiment for mitigating PCI during fuel bundle design and core design optimization. Within the embodiment are seven evaluations (PCI Evaluation Methods 1-7), which are the evaluations used to mitigate PCI.

### Example Embodiment

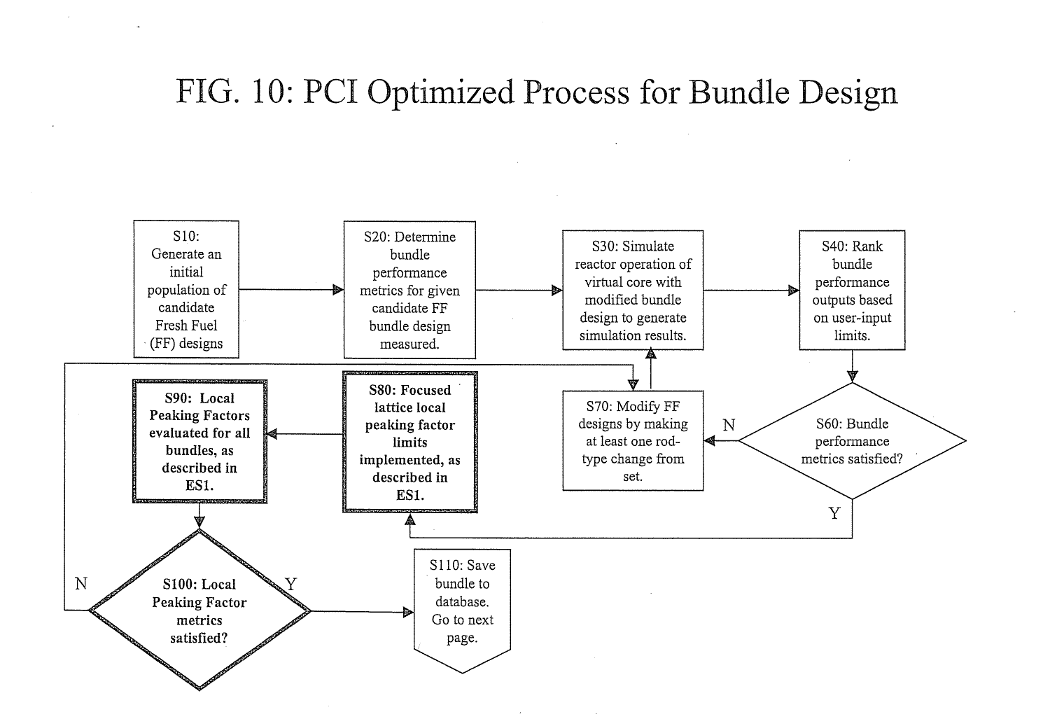

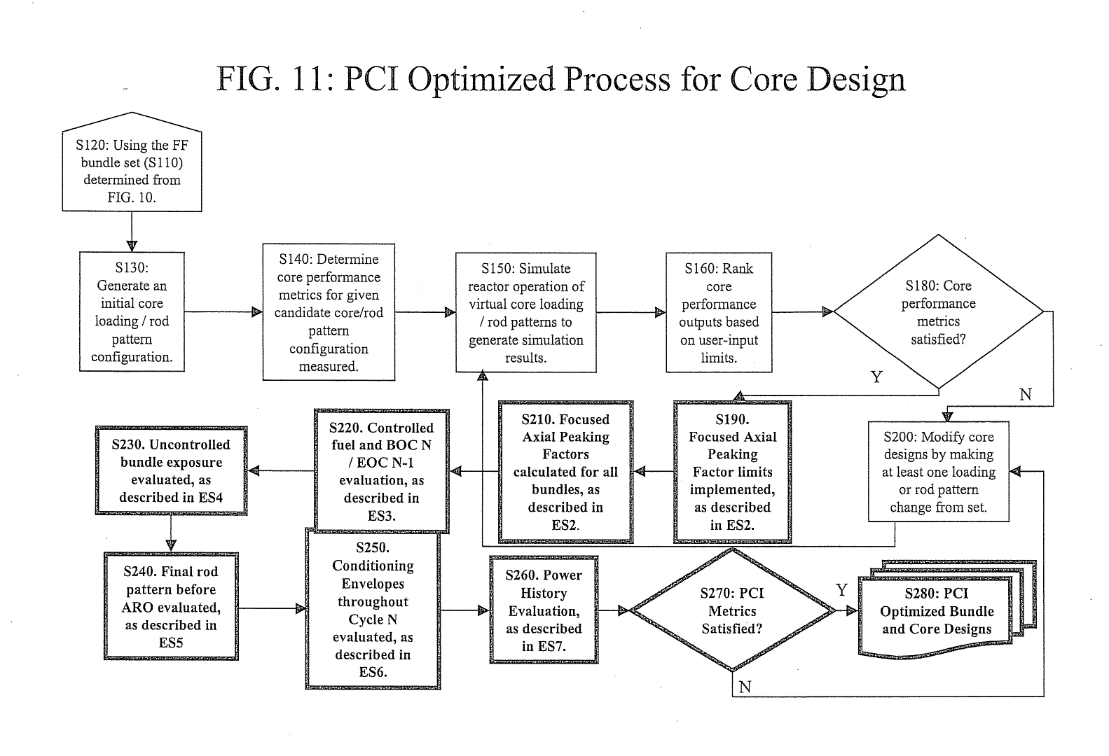

FIGS. 10 and 11 describe an example embodiment of fuel bundle and core design, respectively. The example embodiments may include several PCI Evaluation Methods, as shown in the highlighted method steps S80-S100 and S190-S280. These method steps are specific to the mitigation of PCI and are described in detail as PCI Evaluation Methods 1-7, included in the FIGS. 10 and 11 discussion, below. It should be noted that the described methodology may be accomplished by a computer, such as a core design computer, or it may be implemented by computer code or a core design simulation program. In particular, some or all of the PCI Evaluation Methods 1-7 may be incorporated into existing core simulators or core monitors, to ensure that PCI mitigation is incorporated into either the fuel bundle design, core monitoring, core design, or both fuel bundle and core design and core monitoring.

It should be noted that fuel bundle and core design evaluation steps shown in FIGS. 10 and 11 are typically performed in an iterative manner. In particular, for the purpose of simulation it is beneficial to first determine initial fuel bundle specifications to then evaluate the operation of the reactor core, as a more refined fuel bundle design cannot be evaluated and determined without an initial core design. Likewise, a more refined core design cannot be determined without including a refined and/or finalized fuel bundle design. For this reason, it is understood that FIGS. 10 and 11 generally describe an iterative process of determining a finalized fuel bundle and core design.

Fuel Bundle Design:

It has been indicated that the fuel bundle design and core design, to a large degree, are intertwined such that iterations are made between making modifications to each. However, it should be noted that FIG. 10 relates more to the determination of fuel bundle design consisting of a determination of UO₂ and Gadolinia enrichments in individual fuel lattices which comprise each individual fuel bundle, whereas FIG. 11 relates more to the determination of core design, which is the consolidation of individual designed fresh fuel bundles in a specified core loading pattern including a comprehensive core operational strategy.

Referring to FIG. 10, a method of initiating fuel bundle and core design may begin with an initial population of candidate fresh fuel, as shown in method step S10. The necessary information to model N×N fuel rod enrichments and other reactivity characteristics may be manually entered by a designer into a database and simulated on a computer using any well-known three-dimensional core simulator, or any other well-known computer software vehicle. An example of a three-dimensional core simulator is PANACEA. Values based on these inputs include the lattice and bundle enrichment (related to PCI acceptability due to resultant peaking factors), R-factors, peaking factors (directly related to PCI), manufacturing requirements, and storage/transport requirements.

Next, in method step S20 all criteria deemed ‘Critical to Quality’ (CTQ), such as customer criteria related to fuel bundle design, such as energy requirements, lattice and bundle enrichments, R-factors, and peaking factors, may then be manually entered by a core designer into the core simulator and then incorporated into the core design.

Based on the fuel bundle performance metrics determined in method step S20, in method step S30 these metrics are then used to simulate the operation of a virtual core. Fuel bundle performance metrics may include lattice and bundle enrichment (related to PCI acceptability due to resultant peaking factors), R-factors, peaking factors (directly related to PCI), manufacturing requirements, and storage/transport requirements. The simulation may be accomplished by the core simulator, and generally may be run for one complete core cycle. The simulator is run using an initial proposed core design. It should be noted that a “core design” refers to both reactor core loading, which defines the positioning of fuel bundles, and fuel rod pattern.

Following the results of the core simulation of method step S30, each fuel bundle may then be ranked by a core designer in method step S40 according to the acceptability criteria noted in S20. The ranking of fuel bundles may include (1) the energy capability of the fuel bundles based on the enrichment distribution, the (2) the margin to reactivity limits for the bundles, (3) the margin to thermal limits of the bundles, as well as any other manufacturing and customer specific constraints. Each bundle is evaluated according to the determined specific acceptability criteria. For example, if a bundle meets all three of the above basic criteria, it is ranked as having a higher potential for use in a core design than a bundle which does not. A bundle which has a low potential when evaluated against the above basic criteria is removed from the initial population of bundles determined in S10. The ranking may be performed for each fuel bundle performance metric described in method step S20.

Based on the bundle ranking accomplished in method step S40, in method step S60 a determination is then made by a core designer as to whether each of the bundle performance metrics is satisfied or not. This evaluation is accomplished for each fuel bundle, individually.

Based on the determination of whether fuel bundle performance metrics are satisfied or not in method step S60, if some or all of the performance metrics have not been satisfied then in method step S70 a modification of the fresh fuel design may then be required. This modification is determined by a core designer using output bundle design characteristics from the core simulator. Specifically, the output bundle design characteristics may be used to determine if fresh fuel bundles contain the requisite enrichment of uranium to meet thermal or reactivity margins while sustaining the required reactor cycle. If fuel design bundle enrichments are to be modified, at least one rod-type from the initial population of fresh fuel bundles is manually changed in the simulator by the designer.

Recommendations for the modification of fresh fuel bundles may be divided into three categories. Namely, energy beneficial modifications, energy detrimental modifications, and modifications that convert excessive margin into additional energy. The preferred approach, if allowable, is to make adjustments using energy beneficial modifications as opposed to energy detrimental modifications, in the interest of conserving energy and power production. Additionally, if loading patterns meet all customer constraints, it is preferable to ensure that all excess margin is converted into additional energy. Described below are logic statements including procedural recommendations for typical bundle performance metrics that may be applied to the modifications of method step S70.

Energy Beneficial Modifications:

A. If Critical Power Ratio (CPR) margin is too low towards the core perimeter, it is preferable to bring more reactive fuel toward the center. Critical Power Ratio is the ratio of the bundle power upon which a portion of the bundle assembly experiences onset of boiling transition to the operating power of the bundle.

B. If a peak pellet exposure threshold is exceeded at EOC, it is preferable to move more reactive (i.e., less exposed) fuel to the problem area of the core. A pellet exposure threshold may be determined based on empirical data of pellet exposures in operating plants that have experienced PCI related failures.

C. If Shutdown Margin (SDM) problem exists at the perimeter of the core at BOC, it is preferable to place less reactive fuel toward the perimeter of the core.

Energy Detrimental Modifications:

A. If CPR margin is too low at EOC, it is preferable to move less reactive fuel to problem locations.

B. If kW/ft margin is too low at EOC, it is preferable to move less reactive fuel into problem locations.

Converting Excessive Margin into Additional Energy:

A. If extra CPR margin is in the center of the core at EOC, it is preferable to move less reactive fuel into problem locations.

Based on the location and time exposure statepoint of the constraint violations as indicated by a constraint problem, such as an objective function (a mathematical summation of weighted penalties and weighted credits), the above recommendations may be used to address constraint problem violations. Specifically, movement of fuel bundles within the core, and changes in fresh fuel bundle enrichments within fuel bundles lattices or within entire fuel rods, may be made to ensure that constraint violations are avoided.

Following the modifications of method step S70, a new reactor simulation of a virtual core is then accomplished in method step S30, and new rankings of fuel bundles are accomplished in method step S40 before a determination is made as to whether the modifications of method step S70 cause all of the bundles to meet the requisite performance metrics in method step S60. An iteration between step S30, S40, S60 and S70 is then performed until all fuel bundles meet the performance metrics as determined in method step S60.

Following any iteration of method steps S30, S40, S60 and S70 to ensure that bundle performance metrics are satisfied in method step S60, bundle PCI characteristics may be evaluated by determining focused Lattice Local Peaking Factor Limits in method step S80, described in PCI Evaluation Method 1, below.

1. Evaluation of Lattice Local Peaking Factor (PCI Evaluation Method 1):

This evaluation examines the lattice Local Peaking factors. A Lattice Local Peaking Factor is calculated from the radial power distribution by dividing the power produced in the highest-powered fuel rod in a lattice cross-section by the average power produced in that cross-section. Therefore, high lattice Local Peaking Factors may increase the magnitude of rapid local power increases resulting in increased risk of Pellet-Cladding Interaction (PCI) type failures. This evaluation relates to the second mitigation method of PCI failures (reducing the rate at which power is increased) by ensuring that power increases are performed at a sufficiently slow ramp rate to maintain the cladding stress below the critical level required for PCI failure or to maintain the inventory of aggressive fission products below the critical level required for PCI failure. Reducing the rate of power increase provides time for cladding stress relaxation to occur during the ramp, thus reducing the cladding stress. Additionally, reducing the rate of power increase reduces the rate of release of embrittling gaseous fission products, and provides time for decay in the aggressiveness of newly released fission products through recombination with other gaseous fission products or with the fuel pellet. Thus, reducing the rate at which a power increase is performed reduces both the cladding hoop stress and the inventory of aggressive fission products.

This evaluation may be used to protect the fuel bundle from PCI by avoiding high radial powers (a higher radial power occurs with a higher Local Peaking Factor) that have conventionally caused breakdown and failures in the integrity of the fuel itself. Specifically, a reduction in the bundle or individual fuel pin enrichment may be made to decrease the Local Peaking Factor, if the Local Peaking Factor value is greater than the selected maximum level. The selected maximum level of the Local Peaking Factor may be considered a threshold value which the Local Peaking Factor shall not exceed.

Following the determination of the focused Lattice Local Peaking Factor Threshold in method step S80, in method step S90 the radial power distribution of every individual fuel bundle design is determined by the three-dimensional core simulator. As shown in FIG. 3, an example radial power distribution is provided. Radial power distributions of each lattice may be determined for each bundle individually. The Lattice Local Peaking Factor is then calculated from the radial power distribution by dividing the power produced in the highest-powered fuel rod in a lattice cross-section to the average power produced in that cross-section. The maximum Local Peaking Factors for each bundle in the core are extracted from the simulator and listed, generally at a 70% void fraction, and at a designated cycle exposure. The Lattice Local Peaking Factor threshold is then defined by compared to empirical data of other Lattice Local Peaking Factors from other nuclear plants, such as a BWR fleet. The empirical data includes the maximum lattice Local Peaking Factors which are selected based on historical Local Peaking Factors that are determined at other operating nuclear plants where PCI has occurred. The result of this comparison is a difference (delta) between the resultant lattice Local Peaking Factor and a maximum lattice Local Peaking Factor.

Following method step S90, in method step S100 a core designer may make a determination as to whether the Local Peaking Factor metrics are satisfied or not. If the metrics are not satisfied then modifications to the fresh fuel design may again be made in method step S70, and a simulation of the reactor may again be performed in method step S30. Another iteration of method steps S30, S40, S60 and S70 (if necessary) may be accomplished to ensure that adjustments in the fuel and core design ensure that both the Local Peaking Factor metric (of method step S100) and fuel bundle performance metrics (of method step S60) are both satisfied. These modifications are made to satisfy the Local Peaking Factor metric to directly determine individual fuel rod powers (and indirectly, enrichments) that may be used in order to satisfy PCI design considerations. Once the bundle performance metrics of S60 and the Local Peaking Factor metrics of S100 are both satisfied, all data on each fuel bundle may be saved to a database or otherwise documented before then proceeding to method step S120 of FIG. 11.

Core Design:

It should be noted that while FIG. 10 pertained more to the design of the fuel bundles themselves, FIG. 11 relates more to the design of the core by making use of the fuel bundles determined in FIG. 10. It should be noted that “core design” refers generally to core loading and rod patterns as they are configured in the reactor core.

Referring to FIG. 11, method step S120 begins with using the set of fresh fuel bundles determined from FIG. 10.

Based on the set of fresh fuel bundles included in method step S120, an initial core loading/rod pattern configuration is then determined in method step S130. This initial core loading/rod pattern configuration may be determined manually by a core designer based on customer preferences and industry experience.

Using the configuration determined in method step S130, a determination of core performance metrics for each candidate core/rod pattern is then performed for each fuel bundle. It should be noted that all criteria deemed “Critical to Quality” (CTQ) to the core design (i.e., designated as “core performance metrics”) may be incorporated into the design by the designer manually entering the performance metrics into the simulator.

Following determination of core performance metrics for each fuel bundle in method step S140, in step S150 a reactor simulation may then be performed. Again a core simulator such as a three-dimensional core simulator may be used in this step. Core performance outputs are determined based on the simulation results.

Based on the core performance outputs of method step S150, a ranking of core performance metrics may then be accomplished in method step S160. This ranking of performance metrics may accomplished by the designer extracting the performance outputs from the simulator. The core performance rankings may be based on user and/or plant-specific limits which may include (1) the energy capability based on the enrichment distribution, the (2) the margin to reactivity limits, (3) the margin to thermal limits, (4) customer flow and control rod pattern operability preferences, (5) margin to exposure limits, (6) reload batch size, (7) control blade friction, and any other customer-specific constraints. Each core design iteration may be evaluated according to this determined specific acceptability criteria.

Based on the core performance rankings of method step S160, in method step S180 a core designer may manually make a determination as to whether core performance metrics are satisfied, based on customer preferences and industry experience and a comparison between the rankings and the core performance metrics of step S140.

If core performance metrics of method step S180 are not satisfied, then output bundle design characteristics from the core simulator may be used to determine if the deviation of a thermal margin, an energy margin, a reactivity margin, or a required reactor cycle is due to a bundle design or a core design characteristic based on the ranked core performance outputs of method step S160. If the deviation is due to a bundle characteristic, modification of at least one rod-type change from the initial population of fresh fuel bundles is manually made by a core designer in method step S70, and an iteration of method steps S30, S40, S60 and S70 is again performed to ensure that all bundle performance metrics are satisfied, which is continued in method step S60, as shown in method step S200. However, if the deviation is due to a core design characteristic, a modification of at least one loading pattern or control rod pattern change from the original set is manually accomplished in method step S200.

Modification of Core Design by Making at Least One Loading or Rod Pattern Change from Set (S200):

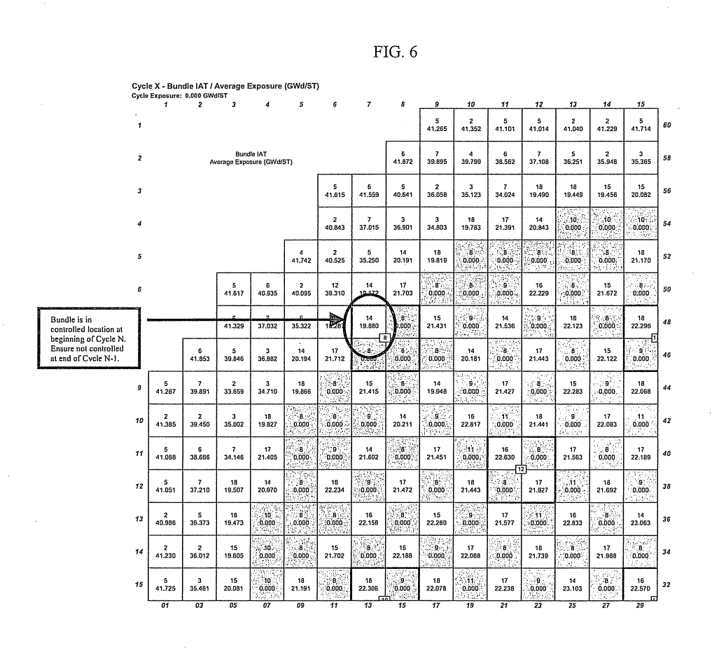

In modifying the core design, first a designer may identify a bundle symmetry option of any potential bundle that may be relocated within the core. Bundle Symmetry refers to the loading scheme of the fuel in the reactor. A typical symmetry option is “Quarter-Core Mirror” in which sets of four symmetric core locations are loaded with bundles that contain similar characteristics, such as similar exposures (see FIG. 6 for an example of one quarter of a typical core). Next, a target bundle may be chosen and a destination is then selected. The identified bundles are then “shuffled” according to the required symmetry, as described above. The process may then be repeated for any/all bundle shuffles required to re-load the core pattern in the manner prescribed by the above core design requirements.

Depending on customer needs, certain bundles may not be allowed to be “shuffled.” Therefore the location of fresh bundles may remain fixed, or fuel bundles from the previous cycle periphery may not be allowed to be “shuffled” to a core interior. Hence, while identifying constraints in the loading pattern design, such client specific limitations may be identified.

Upon completion of a core design adjustment in method step S200, simulation of the modified core is again accomplished in method step S150, and iterations through steps S160, S180, and S200 are then repeated as necessary to ensure that all core performance metrics extracted by the core simulator are satisfied, as determined manually in method step S180 by a core designer.

Once all core performance metrics are satisfied in method step S180, reactor core PCI characteristics may then be evaluated by implementing the focused axial peaking factor as shown in method step S190, described in detail as PCI Evaluation Method 2, below.

2. Focused Axial Evaluation and Determination of Axial Limits (PCI Evaluation Method 2):

This evaluation examines the axial Local Peaking Factors, since high axial Local Peaking Factors increase the potential for a rapid power increase resulting in Pellet-Cladding Interaction (PCI) failures. This evaluation relates to the second mitigation method of PCI failures (reducing the rate at which power is increased) by ensuring that power increases are performed at a sufficiently slow ramp rate to maintain the cladding stress below the critical level required for PCI failure or to maintain the inventory of aggressive fission products below the critical level required for PCI failure. Reducing the rate of power increase provides time for cladding stress relaxation to occur during the ramp, thus reducing the cladding stress. Additionally, reducing the rate of power increase reduces the rate of release of embrittling gaseous fission products, and provides time for decay in the aggressiveness of newly released fission products through recombination with other gaseous fission products or with the fuel pellet. Thus, reducing the rate at which a power increase is performed reduces both the cladding hoop stress and the inventory of aggressive fission products.

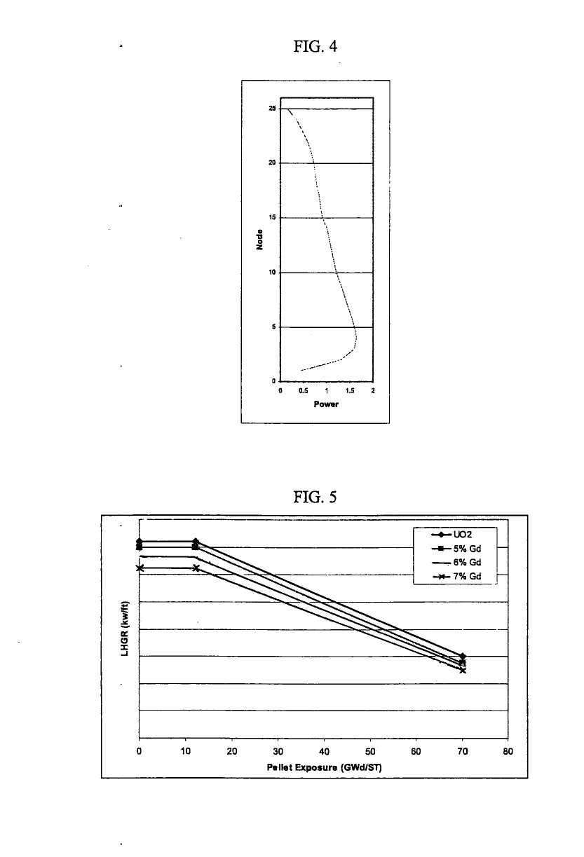

In the evaluation, every fuel bundle in a nuclear core has an axial power distribution, as shown for instance in FIG. 4. Whereas PCI Evaluation Method 1 (Evaluation of Local Peaking Factor) determines pin-by-pin powers providing a designer (i.e., a nuclear reactor designer) the ability to consider radial fuel rod limits in the design process, this evaluation determines the axial power distribution for every bundle in the core. The fuel rods located in the corner and edge positions of a fuel bundle receive the greatest delta-power changes (increases) during control blade withdrawal (i.e., the fuel rods in corner/edge positions are closest to the control blades, and thus they operate at lower power than other fuel rods while the control blades are inserted, and therefore see the greatest increases in power upon withdrawal of the control blades). By extracting the axial power profile of a fuel bundle from the core simulator and then manually comparing the locations of peak axial power to locations where control blade withdrawal occurs, a core designer is able to identify the rods and pellets at the corners/edges which are at particularly high risk of PCI. This enables the designer to then manually incorporate pellet/node enrichment modifications at an appropriate axial level based on results of the individual limits applied as detailed below.

This evaluation includes considering different Linear Heat Generation Rate (LHGR) limits and ramp rate restrictions for pellet types with and without Gadolinia. A “maximum LHGR” in a nuclear core is a fuel rod with the highest surface heat flux at a given nodal plane within a bundle. As shown for instance in FIG. 5, there are different Thermal Mechanical Limits for Gadolinia and UO₂ (Uranium Dioxide) rods, to ensure that the stresses, strains, and fatigue life of fuel rod and fuel bundle components do not exceed material ultimate stress, strain and material fatigue capabilities. The Thermal Mechanical Limits are therefore a bounding set of constraints (the constraints include nuclear and non-nuclear heating limits) to ensure that under normal and abnormal reactor conditions, bundle integrity is maintained. It should be noted that Thermal Mechanical Limits may vary for fuel product lines and individual UO₂ and Gadolinia pins within fuel product lines.

Incorporating different Thermal Mechanical Limits into each individual axial node enables a core designer to identify and avoid high nodal powers that may otherwise cause fuel failures and subsequent PCI. By specifying accurate Thermal Mechanical Limits for each rod, a conservative determination of Thermal Mechanical Limits may then be applied to all fuel pins and fuel types in the core. It should also be understood that a tradeoff occurs as an increase in Thermal Mechanical Limits decreases the nodal power ratio of the rods.

PCI Evaluation Methods 1 (Lattice Local Peaking Factor) and 2 (Focused Axial Evaluation and Determination of Axial Limits) are evaluations primarily used to provide a core designer with data that may be used for bundle or lattice design modifications. Such modifications to the lattices may include adjusting either the lattice or bundle UO₂ enrichment distribution or Gadolinia concentrations. It should also be noted that by suppressing the power of bundles in the reactor core with control blades (which contain burnable poison) for a long time period or exposure interval (for instance, for periods exceeding 5,000 MWd/ST), localized power increases occur rapidly upon control blade withdrawal. A rapid increase is known to cause fuel performance issues related to PCI, and therefore the aim of this evaluation includes a reduction in such rapid increases in localized power. Generally, simulations of one complete cycle of BWR operation are performed for this evaluation. Resultant design parameters, including thermal and reactivity margins, are determined based on the reactors planned power, flow history, and control rod pattern strategy.

PCI Evaluations Methods 1 and 2 may be beneficial in determining at what time during the reactor cycle PCI may become more of a concern. However, in PCI Evaluation Methods 3-5, a complete simulation of an operating reactor core is performed in order to primarily evaluate the history of the consequential control blade positions during the complete simulation.

Following method step S190, axial peaking factors for every bundle (fresh, and once burnt fuel) in the reactor core is then evaluated in method step S210, as described in more detail in PCI Evaluation Method 2 (Focused Axial Evaluation and Determination of Axial Limits). In S210 of PCI Evaluation Method 2, axial peaking factors are calculated to determine at which axial (nodal) level in the core the power is greatest. This calculation occurs at a defined cycle exposure for every bundle in the core.

As a part of method step S210, axial evaluations of all bundles in the core are accomplished. Specifically, design characteristics such as core location and duration and the magnitude of deviation are used to determine whether deviations in the axial evaluations are due to fuel bundle characteristics or core design characteristics. If problems in bundle design are at issue, modification of at least one rod-type change is manually made in method step S70 and an iteration of method steps S30, S40 and S60 is again performed, as shown in FIG. 10. If problems in core design are an issue, modification of the core design is accomplished by manually changing a loading or rod pattern and then iterating through method steps S150, S160, and S180 to ensure that all core performance metrics are satisfied.

Following the focused axial evaluations for all bundles in method step S210, in method step S220 PCI Evaluation Method 3 is used to evaluate the controlled fuel at BOC N/EOC N−1, as described in detail below.

3. Evaluation of Controlled Fuel at Beginning-of-Cycle (BOC) N and End-of-Cycle (EOC) N−1 (PCI Evaluation Method 3):

This evaluation examines the control history of bundles, as an increase in the duration of the low power period between periods of higher power operation increases the potential for PCI failures. This evaluation relates to the first PCI mitigation method (reduction in the duration of the low power period between periods of higher power operation) and is most easily understood as being applied to control blade sequence exchanges. In this case, if the controlled interval is sufficiently small, the fuel pellet and cladding deformation mechanisms will not progress sufficiently to significantly close the pellet-cladding gap at low power, so that a return to a prior high power level does not result in significantly increased cladding stress. Additionally, with a sufficiently short “controlled” period, an insufficient inventory of embrittling fission products will be generated and subsequently released during the return to the higher power level, and stress corrosion crack initiation will therefore not occur.

During the design phase, a complete simulation of fuel bundle exposure is accomplished. The simulation may be for instance one complete reactor cycle using a planned operational strategy. Therefore, all power and flow conditions, and all planned control blade maneuvers are included in the simulation. In this evaluation, the core designer extracts a list of bundle identification numbers of fuel bundles that are controlled during a simulation of a final sequence of Cycle N−1 (a cycle before projected refueling) and a first sequence of Cycle N (a cycle after projected refueling). The designer may choose to manually modify the core loading to move one or more of the fuel assemblies on this list to an “uncontrolled” location. Alternatively, the designer may manually modify the planned rod pattern to insert a control rod in a different location in the core to remove the “control” of that particular fuel assembly. This may allow a core designer to ensure that any one particular bundle is not “controlled” for an extended period of time, thereby lessening the likelihood that PCI-related fuel failures may otherwise occur due to controlled exposure. The output of this evaluation includes a design specification for individual fuel bundles that may be acceptable for use in “controlled” locations at the beginning of the design cycle following a projected refueling. This evaluation also provides a listing of fuel assemblies that are unacceptable in “controlled” locations. PCI is therefore mitigated, by ensuring that any fuel bundle is not “controlled” for longer than a specified length of time.

FIG. 6 includes an example embodiment of a once-burnt fuel bundle at the beginning of its second cycle of operation. The fuel bundle is in a controlled location in the current (second) cycle, as demonstrated by Notch 8 indicated in the center of the 4-bundle control cell. For any already-exposed (once-, or twice-burnt) fuel bundle, the control history of the previous cycle (Cycle N−1) may be evaluated. If there are any “controlled” bundles at the beginning of a current cycle that were also controlled at the end of the previous cycle, a list of these particular bundles are part of the output of this evaluation. A particular bundle that has been “controlled” at the beginning of a cycle that was also controlled at the end of the previous cycle has a higher probability of demonstrating characteristics of power suppression. Therefore, such a bundle is potentially at higher risk for PCI failures due to the power increase at the time of the eventual control blade withdrawal. The PCI Evaluation Method 3 metric would therefore not be satisfied in this situation.

Following method step S220, in method step S230 PCI Evaluation Method 4 is used in determining conditioning envelopes throughout Cycle N.

4. Evaluation of Uncontrolled Bundle Exposure at BOC (PCI Evaluation Method 4):

This evaluation examines the control history of fuel bundles, as an increase in the duration of the low power period between periods of higher power operation increases the potential for PCI failures. This evaluation relates to the PCI Evaluation Method 3, as this evaluation is more easily understood as being applied to control blade sequence exchanges. In this evaluation, if the controlled interval is sufficiently small then fuel pellet and cladding deformation mechanisms will not progress sufficiently to significantly close the pellet-cladding gap at low power so that a return to the prior high power level does not result in significantly increased cladding stress. Additionally, with a sufficiently short “controlled” period, an insufficient inventory of embrittling fission products will be generated and subsequently released during the return to the higher power level, and stress corrosion crack initiation will therefore not occur.

While PCI Evaluation Method 3 (Evaluation of Controlled Fuel at Beginning-of-Cycle (BOC) N and End-of-Cycle (EOC) N−1) identifies the fuel bundles that are controlled in the last sequence of Cycle N−1 and the first sequence of Cycle N, PCI Evaluation Method 4 identifies the duration of control in the previous cycle of all fuel bundles that are controlled in the first sequence of Cycle N regardless of whether the bundles were controlled at the end of Cycle N−1. It is desirable to avoid having a bundle “uncontrolled” for only a short period of time during the end of Cycle N−1 and then “controlled” at the beginning of Cycle N, as such a bundle would have a higher probability of demonstrating characteristics of power suppression. Such a bundle may potentially be at higher risk for PCI failures due to the power increase at the time of an eventual control blade withdrawal. Therefore, PCI Evaluation Method 4 investigates the detailed control history of all fuel bundles identified in PCI Evaluation Method 3 which were “controlled” in a current cycle.

PCI Evaluation Method 4, as it Relates to Example Embodiments of the Current Method (Method Step S230):

PCI Evaluation Method 4 measures the duration of time each bundle is not “controlled.” If the duration is short, the overall control history of the bundle may be considered cumulative as such a bundle will still have a higher probability of demonstrating characteristics of power suppression. Therefore, the bundle is potentially at higher risk for PCI failures due to power spikes that may occur during an eventual control blade withdrawal. The PCI Evaluation Method 4 metric would therefore not be satisfied in such a situation.

In this evaluation, the duration of “uncontrolled time” may be extracted from the core simulator for each bundle that has been identified as “controlled” in a current cycle, to determine bundle exposure periods, which may be a measure of the energy produced by a particular fuel bundle in the reactor core. The “uncontrolled” bundle exposure is a measurement of time, which may be calculated as follows.

EXP_{Bundle}=Bundle Power (MWt)*Number Days (d)/Bundle Weight (ST) (Equation 1)

The “uncontrolled” bundle exposure for all fuel that is controlled during the first sequence of Cycle N may be determined and manually compared to an acceptable threshold determined by empirical data, which may be compiled from other operating BWRs. This threshold is based on a database of values, that have been compiled as empirical data, which have been known to cause PCI related failures in the past. This allows a core designer to avoid “controlling” any given fuel bundle for too long over the course of two consecutive cycles by ensuring that the core loading or control rod pattern maintains all “controlled” bundle exposures above an acceptable “uncontrolled” duration threshold. As described in PCI Evaluation Method 3, there is a desire to minimize the “controlled” exposure of a fuel bundle to avoid a large power spike when a bundle becomes “uncontrolled.” Contrary to PCI Evaluation Method 3, this evaluation may determine the last time that a bundle was “controlled.” This evaluation therefore ensures that a bundle is not “uncontrolled” for a relatively short period of time prior to the end of Cycle N−1 and then “controlled” during the beginning of Cycle N. As in PCI Evaluation Method 3, if this “controlled” interval is sufficiently small then fuel pellet and cladding deformation mechanisms will not progress sufficiently to significantly close the pellet-cladding gap at low power so that a return to the prior high power level does not result in significantly increased cladding stress. Additionally, with a sufficiently short “controlled” period, an insufficient inventory of embrittling fission products will be generated and subsequently released during the return to the higher power level, and stress corrosion cracking will therefore not occur. If either PCI Evaluation Methods 3 or 4 indicates a “controlled” period of time greater than a defined threshold, the designer may return to step S200 to manually make a core loading and/or control rod pattern change and proceed through the evaluations steps again.

Following method step S230, in method step S240 PCI Evaluation Method 5 is used to evaluate the final rod pattern before ARO, as described in detail below.

5. Evaluation of a Final Rod Pattern Before All-Rods-Out (ARO) in Cycle N (PCI Evaluation Method 5):

This evaluation examines the “control” history of each fuel bundles, as an increase in the duration of the low power period between periods of higher power operation increases the potential for PCI failures. This evaluation relates to the first PCI mitigation method (reducing the duration of the low power period between higher power operation), which may be understood as an evaluation of control blade sequence exchanges. It should be noted, if the controlled interval is sufficiently small, the fuel pellet and cladding deformation mechanisms will not progress sufficiently to significantly close the pellet-cladding gap at low power, such that a return to the prior high power level does not result in significantly increased cladding stress. Additionally, with a sufficiently short controlled period, an insufficient inventory of embrittling fission products will be generated and subsequently released during the return to the higher power level, and stress corrosion crack initiation will therefore not occur.

“Control” history of fuel bundles is a mitigating factor in preventing fuel failures related to PCI. The individual “control” history of a bundle can be considered cumulative across multiple cycles until bundle discharge, and a bundle with a relatively long “control history” will have a higher probability of demonstrating characteristics of power suppression. Therefore, the bundle may be potentially at a higher risk for PCI related failures due to power increases that may occur at the time of an eventual control blade withdrawal. Therefore, there is a possibility for a rapid increase in reactor power upon withdrawal of control rods to an All-Rods-Out (ARO) condition with control blades in locations of the reactor core that are not central or symmetric around the center or in other configurations which result in a high power increase upon control rod withdrawal. It is not recommended to design a Final Rod Pattern before ARO using these control rods. Conventional operation of nuclear reactors has shown that certain combinations of rods are more likely to produce a PCI-related failure upon withdrawal of the control rods to an ARO position. To avoid these combinations, the final control rod pattern prior to ARO in Cycle N is therefore manually examined to ensure that such control rods are symmetric around the center of the core and that there are no withdrawals in higher power regions of the core. This enables a core designer to reduce the likelihood of PCI-related fuel failures resulting from withdrawal of a final control rod pattern. The output of this evaluation is a simple discrete measure of acceptability of this final control rod pattern. If this rod pattern is not acceptable, the designer may return to step S200 to manually make control rod pattern changes and proceed through the evaluation steps again.

Following method step S240, in method step S250 PCI Evaluation Method 6 is used to evaluate conditioning envelopes throughout cycle N.

6. Evaluation of Conditioning Envelopes Throughout Cycle N (PCI Evaluation Method 6):

PCI Evaluation Method 6 examines the conditioning envelopes in order to decrease the potential for Pellet-Cladding Interaction failures. This evaluation relates to the second mitigation method of PCI failures by ensuring that power increases are performed at a sufficiently slow ramp rate to maintain the cladding stress below the critical level required for PCI failure or to maintain the inventory of aggressive fission products below the critical level required for PCI failure. Reducing the rate of power increase provides time for cladding stress relaxation to occur during the ramp, thus reducing the cladding stress. Additionally, reducing the rate of power increase reduces the rate of release of embrittling gaseous fission products, and provides time for decay in the aggressiveness of newly released fission products through recombination with other gaseous fission products or with the fuel pellet. Thus, reducing the rate at which a power increase is performed reduces both the cladding hoop stress and the inventory of aggressive fission products.

Mitigation of PCI has traditionally been implemented via “soft” operating practices. “Soft” operating practices include frequent sequence exchanges, performing control blade movements at reduced power and the use of power thresholds, conditioned operation when operating at power levels above the threshold power levels, power ramp rates, and power deconditioning while operating at powers below the conditioned envelope. A beneficial method of PCI-mitigating operating practices may be “soft” power increases performed at a controlled power increase (ramp) rate particularly following long periods of low power operation. Features of a “soft” power increase include: (1) an LHGR (power) threshold, or prior conditioned envelope below which cladding hoop stress or the inventory of newly released embrittling fission products, or both, are below specified limits, and (2) a specified rate of power increases above a threshold or conditioning envelope.

This evaluation therefore determines PCI conditioning envelopes throughout a cycle of interest. The core design is evaluated throughout an entire cycle to determine how much margin exists within an envelope. Conditioning thresholds may be established by maintenance of an increased power condition for a defined period and may be updated periodically during the simulation. All nodes for every fuel bundle are manually compared to these thresholds. For instance, conditioning thresholds may be updated weekly over the course of a cycle. Based on this information, a designer may determine how often and to what extent power changes are experienced that challenge the thresholds, or result in large increases above previously conditioned power levels. The designer may then identify these points of the cycle as a potential risk, and return to steps S70 or S200 to reduce the likelihood of PCI-related fuel failures, and redesign to a lower LHGR, if desired.

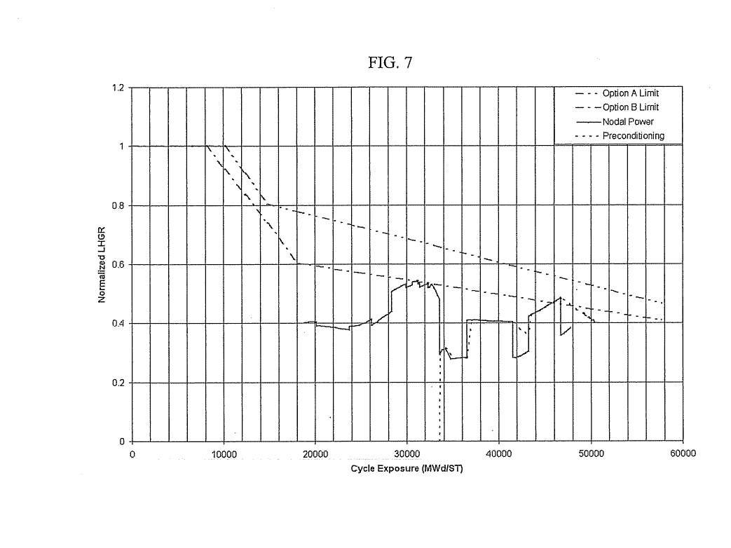

During simulations, optional LHGR thresholds may be used to protect the fuel before the fuel is placed in operation. FIG. 7 shows an example power history with a preconditioning threshold and two optional LHGR thresholds (Option A or B) for a given bundle or node. Option A or B thresholds are LHGR thresholds based on peak pellet and nodal exposures, and therefore are not changed or updated during a simulation. Option A is an LHGR threshold based on fuel assembly design characteristics and industry database values. Option B is a more conservative LHGR threshold based on fuel assembly design characteristics, industry database values, and expected fuel assembly operational history. Either option may be used depending on the particular PCI risk management requirements and strategy of a plant, and/or customer preferences. A preconditioning threshold is an additional restriction beyond the Option A or B thresholds, and includes consideration of the history of the location of the fuel, and the fuel's energy and performance capabilities. If a node is operated above the Option A or B thresholds, it is recommended that the node should be ramped up to each power increase at a slower rate. If a node has already been at that power, the preconditioning threshold allows the node to return to that power without ramping. The preconditioning threshold is only implemented when nodal power exceeds the Option A or B limits. Below the Option A or B thresholds, nodal power may increase or decrease at any rate without restrictions being placed on the rate. Above these thresholds, implementation of the preconditioning threshold is recommended. This evaluation step provides the nodal power history of every fuel assembly in the core. By selecting any individual fuel assembly, the designer is able to view this nodal power history, and manually compare this history against the Option A threshold, Option B threshold, and preconditioning threshold. If a nodal power history of a fuel assembly is below all three optional thresholds, the fuel bundle and core design may be considered acceptable. In the event that the nodal power of a fuel assembly is above one of the thresholds, the designer then makes a determination as to how much PCI risk is introduced by this output characteristic. If the designer determines that the risk level is not acceptable, based on customer preferences and industry experience, the designer may return to steps S70 or S200 to manually make a bundle or core design change and proceed through the evaluations steps again.

Following method step S250, in method step S260 PCI Evaluation Method 7 is used to evaluate the power history of each fuel bundle, as described in detail below.

7. Evaluation of Power History of Fuel Bundles and Nodes (PCI Evaluation Method 7):

PCI Evaluation Method 7 examines the power history of fuel bundles and nodes in order to decrease the potential for Pellet-Cladding Interaction failures. This is related to the second mitigation method of PCI failures by ensuring that power increases are performed at a sufficiently slow ramp rate to maintain the cladding stress below the critical level required for PCI failure or to maintain the inventory of aggressive fission products below the critical level required for PCI failure. Reducing the rate of power increase provides time for cladding stress relaxation to occur during the ramp, thus reducing the cladding stress. Additionally, reducing the rate of power increase reduces the rate of release of embrittling gaseous fission products, and provides time for decay in the aggressiveness of newly released fission products through recombination with other gaseous fission products or with the fuel pellet. Thus, reducing the rate at which a power increase is performed reduces both the cladding hoop stress and the inventory of aggressive fission products.

This evaluation determines the power history of each fuel bundle to ensure that a future peak power does not exceed any earlier peak power are recorded by the operational history of the bundle, as operational experience indicates that this has been a precursor element to PCI-type failures. When a fuel rod's power is increased above its historical pre-conditioned level, the cladding may experience the largest stress increase of its operating lifetime, and the release of embrittling fission products may also be maximized. This evaluation is generally detailed as follows.

A) Generate a power history for all fuel bundles and all nodes, starting on the first day of operation.

B) Store all nodal exposures, nodal powers, and control history data before and after every group rod pattern change, and after any change in control rod positions.

C) Track, by storing the nodal power and exposure history data, the power history for the core, for all nodes throughout the lifetime of the fuel.

D) Determine a threshold value for each fuel bundle, as detailed in PCI Evaluation Method 6 (an Evaluation of Conditioning Envelopes throughout Cycle N). The threshold value may be in terms of kW/ft, and may be as a function of nodal exposure.

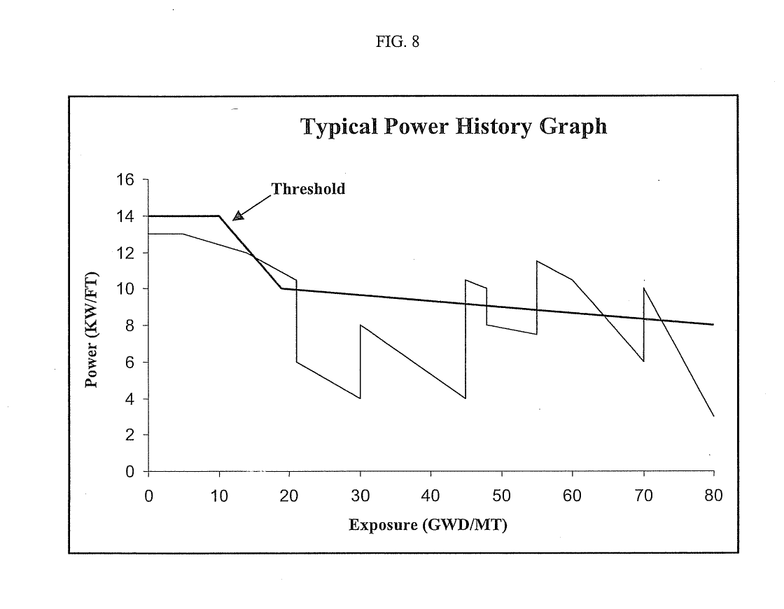

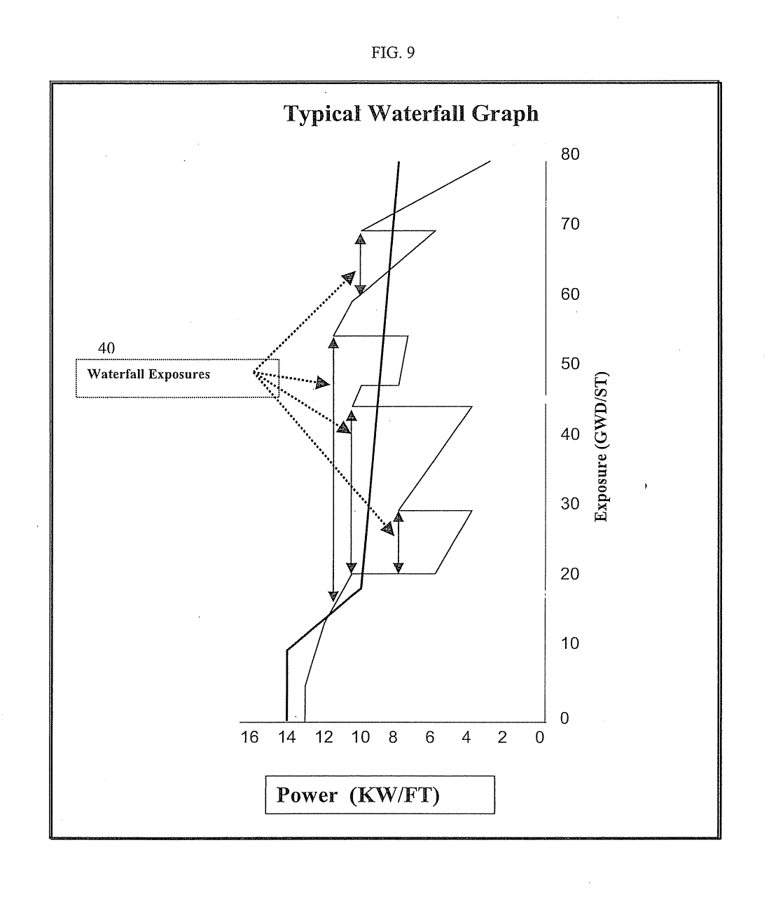

E) For each time exposure state point (point at which nodal power and exposure history data is collected/stored), calculate a “waterfall” exposure interval for all of the nodes that increased in power from the previous state point. A “waterfall” exposure interval may be calculated graphically by rotating a power history graph 90 degrees and then determining how far a drop of water would fall before it hit the “ground” (See an example power history graph in FIG. 8, and a “waterfall” exposure graph that has been rotated 90 degrees in FIG. 9). As shown in FIG. 9, these “waterfall” exposures 40 represent the duration of time since the power level of the fuel bundle has last been at or above its current power level. It should be noted that a power level is considered to be zero when a node is controlled.

F) The “waterfall” exposure data may then be evaluated with respect to PCI propensity by assigning a numerical value of a “PCI threat” to each bundle. The assignment of numerical values may vary for different core designs, and the embodiment below illustrates one way that this may be accomplished:

i. Any node with an exposure of less than 10 GWd/ST may be assigned a numerical PCI threat of 0.0.

ii. Any individual node with a nodal exposure of less than 42 GWd/ST and a peak fuel rod value (in kW/ft) of greater than the acceptable threshold level (or, its prior conditioned envelope value) may have a PCI threat. This threat is a function of the peak fuel rod in the node and the waterfall nodal exposure interval. The higher the peak fuel rod value (in kW/ft) in the node, and the higher the “waterfall” exposure interval, the higher the PCI threat level. A threat level may be determined by the following equation.

Threat=((peak nodal kW/ft result−threshold kW/ft−1.0 kW/ft)*2 (waterfall exposure GWd/ST))/(1.0 kW/ft/MWd/ST) (Equation 2)

Therefore, the Relative Threat level may be considered a function of delta nodal power, nodal power, exposure, and waterfall exposure. While an example of this relationship is described above, but may be shown to exist in other similar embodiments.

G) All “PCI threat” values may be used to identify fuel bundles and nodes that a core designer may then use to adjust if necessary, or further evaluate with a damage index ranking. A damage index ranking would be defined as ranges of threat levels. For example, a low damage index ranking could be a calculated Threat Result of less than 10.0. A moderate damage index ranking could be a calculated Threat Result of between 10.0 and 150.0, and a high damage index ranking could be a calculated Threat Result of greater than 150.0. Note that all numbers are simply examples, as these values are defined based upon plant and fuel characteristics and customer preferences. A damage index ranking may also be calculated with online data after the core has been designed and is already operating. At this point, the PCI threat values may be used to identify potential PCI concerns and pedal iii operational adjustments, if necessary.

Following the power history evaluation in method step S260, in method step S270 a deter is made as to whether all of the PCI metrics of method steps S190 (PCI Evaluation Method 1), S210 (PCI Evaluation Method 2), S220 (PCI Evaluation Method 3), S230 (PCI Evaluation Method 4, S240 (PCI Evaluation Method 5), S250 (PCI Evaluation Method 6) and S260 (PCI Evaluation Method 7) have been satisfied. If all metrics have not been satisfied then output characteristics of the core simulator may be used to determine if the deviation is due to a bundle characteristic or a core characteristic. If the deviation is a core characteristic in method step S200 as further modifications of the core design may be made by making at least one modification to the core loading or rod pattern and then iterating through method steps S150, S160 and S180 to ensure that all core performance metrics are satisfied. If the deviation is a fuel bundle characteristic, then at least one rod-type change may be made in method step S70 as the process then iterates through method steps S30, S40, and S60 to ensure that all bundle performance metrics are satisfied. Following a modification to the fuel bundle in method step S70, the method may follow through the remainder of the process shown in FIGS. 10 and 11 to again use PCI Evaluation Methods 1-7 (in method steps S80, S190, S210, S220, S230, S240, S250 and S260) to mitigate PCI (and, likewise if a modification of the core design is accomplished in method step S200, following such modification the process may again iterate through the remainder of FIG. 11 which may include method steps S190, S210, S220, S230, S240, S250 and S260).

If it is determined in method step S260 that all of the PCI metrics have been satisfied by the fuel bundle and core design (i.e., all of PCI Evaluation Methods 1-7), then in method step S280 the core design and the individual fuel bundle design of all fresh fuel may be saved, as the fuel and core design have been optimized for performance metrics and PCI mitigation. The reactor core may then be operated using this design.

Having described an Example Embodiment as shown in FIGS. 10 and 11, it should be understood that all of the steps included in the figures need not be performed in the order shown in the figures, especially as they relate to PCI Evaluation Methods 1-7. Additionally, not all of the PCI Evaluation Methods need to be performed.

For those reactor cores already through the design process prior to and during operation, the PCI Evaluation Methods 1-7 may still be performed to determine key PCI-related features and results of a provided core and bundle design. The inputs to applying Evaluation Methods to core operation are based on actual measurements instead of projected operation. In such a case, the PCI metrics may not have been satisfied by the provided fuel bundle and core design (i.e., all of PCI Evaluation Methods 1-7), and the fuel and core design may not be optimized for performance metrics and PCI mitigation. However, the information calculated by PCI Evaluation Methods 1-7 would provide the designer and plant with the appropriate data to determine a risk management strategy for PCI.

As described above, example embodiments of the described method may be implemented using any well-know three-dimensional core simulator that is operated on a computer, or a computer system with access to a network providing communication between internal and external users that may access the computer system. An example embodiment of the structure of a computer that may implement example embodiments is described below.

Computer System for Implementing Example Embodiments:

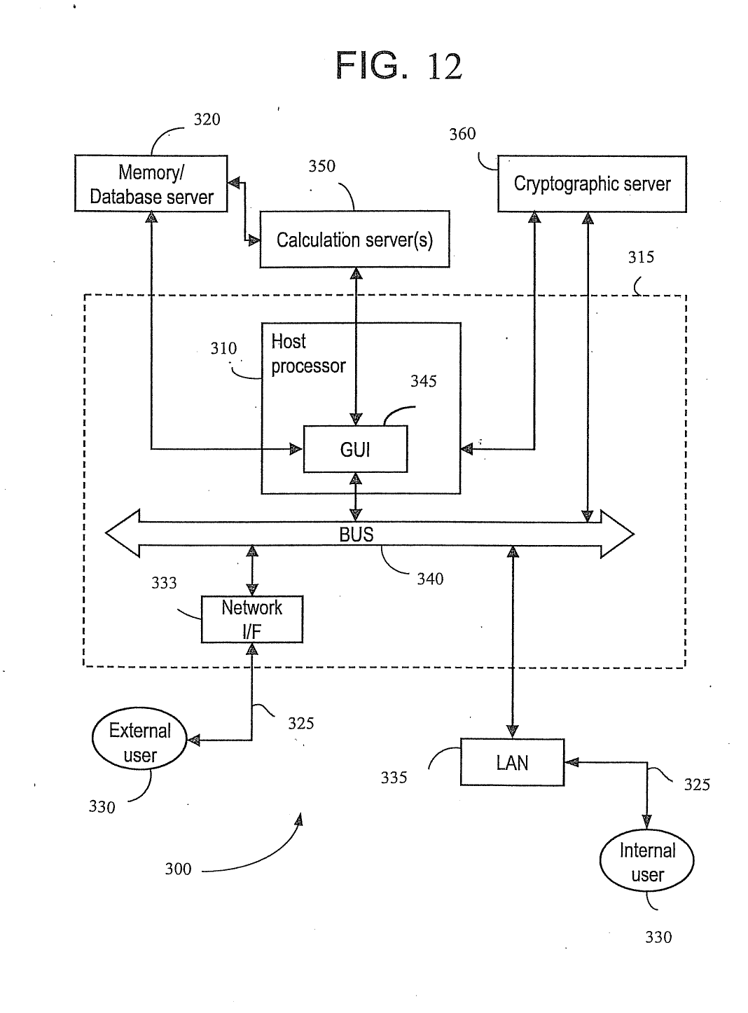

FIG. 12 illustrates an arrangement 300 for implementing the method in accordance with and exemplary embodiment of the invention. Referring to FIG. 12, arrangement 300 may include a processor 310 that communicates with an internal memory 320, which may contain a database storing data used to operate a computer simulator. Processor 310 represents a central nexus from which three-dimensional core simulator software may be implemented, which may include a graphical-user interface (GUI) and browser functions, directing all calculations and accessing data required to run the simulator software. For example, processor 310 may be constructed with conventional microprocessors such as currently available PENTIUM processors.

Arrangement 300 may be embodied as a network. Processor 310 may be part of an application server 315 (shown in dotted line) on the network for access by both internal and external users 330, via suitable encrypted communication medium such as an encrypted 128-bit secure socket layer (SSL) connection 325, although the present invention is not limited to this encrypted communication medium. Hereinafter, the term user may refer to both an internal user and an external user. A user may connect to the network and input data or parameters over the internet from any one of a personal computer, laptop, personal digital assistant (PDA), etc., using a suitable input device such as a keyboard, mouse, touch screen, voice command, etc., and a network interface 333 such as a web-based inter net browser. Further, processor 310 on such a network could be accessible to internal users 330 via a suitable local area network (LAN) 335 connection, for example.

The graphical information may be communicated over the 128-bit SSL connection 325 or LAN 335, to be displayed on a suitable terminal unit such as a display device of the user 330, PDA, PC, etc. For example, a user 330 may be any of a representative of a nuclear reactor plant accessing the website to determine a fuel bundle configuration or core design for his or her nuclear reactor, a vendor hired by a reactor plant site to develop core designs using the exemplary embodiments of the present invention, or any other user authorized to receive or use the information generated by the exemplary embodiments of the present invention.

Processor 310 may be operatively connected to a cryptographic server 360. Accordingly, processor 310 may implement all security functions by using the cryptographic server 360, so as to establish a firewall to protect the arrangement 300 from outside security breaches. Further, cryptographic server 360 may secure all personal information of all users registered with a website hosting a program implemented by the method and arrangement 300 in accordance with example embodiments.

If processor 310 is part of an application server 315 on a network, for example, conventional bus architectures may be used to interface between components, such as peripheral components interconnect (PCI) bus (340) that is standard in many computer architectures. Alternative bus architectures such as VMEBUS, NUBUS, address data bus, RAMbus, DDR (double data rate) bus, etc. could of course be utilized to implement such a bus.

Processor 310 may include a GUI 345, which may be embodied in software as a browser. Browsers are software devices which present an interface to, and interact with, users of the arrangement 300. The browser is responsible for formatting and displaying user-interface components (e.g., hypertext, window, etc.) and pictures.

Browsers are typically controlled and commanded by the standard hypertext mark-up language (HTML). Additionally, or in the alternative, any decisions in control flow of the GUI 345 that require more detailed user interaction may be implemented using JavaScript. Both of these languages may be customized or adapted for the specific details of a implementation, and images may be displayed in the browser using well known JPG, GIF, TIFF and other standardized compression schemes, other non-standardized languages and compression schemes may be used for the GUI 145, such as XML, “home-brew” languages or other known non-standardized languages and schemes.

As noted above, processor 310 may, in conjunction with a three-dimensional core simulator, perform all simulations that may then generate data stored in memory 320, as to be described in further detail below. This data may be displayed on a suitable display, via the GUI 345, under the direction of processor 310.

Memory 320 may be integral with processor 310, external, configured as a database server, and/or may be configured within a relational database server, for example, that may be accessible by processor 310. Alternatively, instead of processor 310 performing simulations, processor 310 may direct a plurality of calculation servers 350, which could be embodied as Windows 2000 servers, for example, to perform simulations.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A method of determining a fuel bundle design to mitigate Pellet Cladding Interaction (PCI) in a nuclear reactor, the method comprising:
first determining, by a computer, the fuel bundle design for a fuel bundle using PCI design considerations.

2. The method of claim 1, wherein the PCI design considerations includes evaluating lattice local peaking factors.

3. The method of claim 2, wherein the first determining step further comprises:
simulating reactor operation using an initial fuel bundle design;
evaluating lattice local peaking factors for the fuel bundle using the initial fuel bundle design;
second determining whether local peaking factor metrics are satisfied for the fuel bundle using the initial fuel bundle design;
modifying the initial fuel bundle design, if the local peaking factor metrics are not satisfied; and
repeating the first determining, simulating, evaluating, second determining, and modifying steps until a modified fuel bundle design is determined which meets local peaking factor metrics.

4. The method of claim 1, wherein the PCI design consideration further includes at least one of evaluating axial peaking factors of the fuel bundle, evaluating simulated control history of the fuel bundle at a Beginning-of-Cycle (BOC) N and an End-of-Cycle (EOC) N−1, evaluating simulated exposure of the fuel bundle at BOC, and evaluating a power history of the fuel bundle.

5. A method of determining core design to mitigate Pellet Cladding Interaction (PCI) in a nuclear reactor, the method comprising:
first determining, by a computer, the core design using PCI core design considerations, prior to operation of the nuclear reactor.

6. The method of claim 5, further comprising:
second determining a fuel bundle design for a fresh fuel bundle using PCI fuel bundle design considerations;
generating an initial core loading and fuel rod pattern for a reactor core, the initial core loading and fuel rod pattern including the fuel bundle design of the fresh fuel bundle;
simulating reactor operation of the core, using the initial core loading and fuel rod pattern;
obtaining core performance metrics and PCI performance metrics based on the simulated reactor operation;
determining a modified core design, based on the core performance metrics and the PCI performance metrics.

7. The method of claim 5, further comprising:
simulating reactor operation of a reactor core, using an initial core loading and fuel rod pattern;
obtaining core performance metrics and PCI performance metrics based on the simulated reactor operation;
modifying the initial core loading and fuel rod pattern, if PCI performance metrics are not met; and
repeating the first determining, simulating, obtaining, and modifying steps until a modified core design is determined which meets the PCI performance metrics, the PCI performance metrics being based on PCI fuel bundle design considerations and the PCI core design considerations.

8. The method of claim 7, wherein the PCI fuel bundle design considerations include evaluation of fuel bundles based on an evaluation of lattice local peaking factors for fuel bundles.

9. The method of claim 7, wherein the PCI core design considerations include simulating and evaluating at least one of axial peaking factors of fuel bundles, control history of fuel bundles at a Beginning-of-Cycle (BOC) N and an End-of-Cycle (EOC) N−1, uncontrolled bundle exposure at BOC, a final rod pattern before All-Rods-Out (ARO) in Cycle N, conditioning envelopes throughout Cycle N, a power history of fuel bundles.

10. A method of determining a fuel bundle design and a core design to mitigate Pellet Cladding Interaction (PCI) in a nuclear reactor, the method comprising:
deter mining, by a computer, the fuel bundle design of at least one fresh fuel bundle using PCI design considerations; and
determining, by the computer, the core design using PCI core design considerations and the determined fuel bundle design of the at least one fresh fuel bundle, prior to operation of the nuclear reactor.
